(19) United States
(12) Patent Application Publication
(10) Pub. No.: US 2015/0021016 A1
(43) Pub. Date: Jan. 22, 2015

(54) DEVICE AND METHOD FOR MEASURING TORQUE AND ROTATION

(71) Applicants: Bing Deng, Edmonton (CA); Murray Gerwing, Edmonton (CA); Gerhard Oberforcher, Edmonton (CA); Trent Michael Schatz, Edmonton (CA)

(72) Inventors: Bing Deng, Edmonton (CA); Murray Gerwing, Edmonton (CA); Gerhard Oberforcher, Edmonton (CA); Trent Michael Schatz, Edmonton (CA)

(73) Assignee: MCCOY CORPORATION, Edmonton, AB (CA)

(21) Appl. No.: 14/117,988

(22) PCT Filed: Mar. 28, 2012
(86) PCT No.: PCT/CA2012/000323

§ 371 Date: Nov. 15, 2013

(51) Int. Cl. E21B 19/16; H04B 5/00; E21B 47/00

(52) U.S. Cl. CPC E21B 19/166; E21B 19/16; E21B 47/00; H04B 5/0031; H04B 5/0037
USPC 166/250.01; 166/65.1; 73/152.49

(57) ABSTRACT

A device is taught for measuring and wirelessly transmitting one or more parameters during wellbore operations. The device comprises a torque sub releasably connected to a top drive at a first end and having a second end such that the torque sub rotates with the rotating top drive, one or more sensors for measuring rotational, torque and torsion parameters, a wireless power source and a signal transmitter connected to the one or more sensors for wireless transmission of data collected by the one or more sensors to a computer. Systems and methods are also provided for connecting threaded tubulars for use in a wellbore.

### FIELD OF THE INVENTION

This invention relates to a device and a system for measuring torque and rotation during a number of wellbore activities.

### BACKGROUND

In down-hole drilling and extraction processes pipe strings, also called drill pipe, tubing or casing strings, are run down the wellbore for the purposes of drilling, performing operations or producing oil from the well. Pipe strings are made up by connecting multiple threaded tubular sections together. Typically, tubulars have a tapered female thread at one end and a tapered male thread at the other end. The male end of a first tubular is threaded into the female end of a second tubular to makeup the tubing string. Certain tubulars are equipped with what are often referred to as premium grade connections. Rotation of the first tubular into the second tubular is conducted until the tapered ends engage one another at the shoulder point. A metal-to-metal seal is thus formed by engagement of the two threaded tubulars.

The integrity of this seal is important to down hole operations, as well as avoiding over-tightening or damaging the tubular sections. There must therefore be a means for measuring makeup parameters and determining satisfactory shouldering, engagement and seal. Manufacturers of premium grade connections provide a range of optimum torque values for proper makeup of specific connections. These optimum torque values can be compared against measured torque values, which can then be plotted against time and number of turns, along with visual inspection of the connection by the operator, to monitor the connection and determine make up acceptability.

Where rotation is performed by way of a top drive, the rotation of the first tubular relative the second tubular and the number of turns has been measured by different means in the past. One method employs the use of a turns counter, or encoder, together with a fixed reference point, often affixed to the top drive, to measure rotation. Such measurements may require a step of correcting for any deflection of the fixed reference point from movement of the top drive. Other methods measure rotational forces and use this data to arrive at a turns count.

The real-time collection and dissemination of rotational and torque parameters during make-up is also an important aspect to acceptable make-up determination. It is important to be able to make an assessment of the tubular string make up during the make-up process and to collect and translate make-up data for future review.

There is a need to develop improved devices and systems for more accurately measuring and transmitting data during tubular makeup, drilling with casing and horizontal wellbore operations.

### SUMMARY

A device is taught for measuring and wirelessly transmitting one or more parameters during wellbore operations. The device comprises a torque sub releasably connected to a top drive at a first end and having a second end such that the torque sub rotates with the rotating top drive, one or more sensors for measuring rotational, torque and torsion parameters, a wireless power source and a signal transmitter connected to the one or more sensors for wireless transmission of data collected by the one or more sensors to a computer.

A device is further taught for measuring and wirelessly transmitting one or more parameters during wellbore operations. The device comprises a torque sub releasably connected to a top drive at a first end and having a second end such that the torque sub rotates with the rotating top drive, one or more sensors for measuring rotational, torque and torsion parameters, a wireless power source and a signal transmitter connected to the one or more sensors for wireless transmission of data collected by the one or more sensors to a computer. The one or more sensors, wireless power source and signal transmitter are enclosed within a housing on the torque sub.

A system is provided for connecting threaded tubulars for use in a wellbore. The system comprises a top drive for imparting rotational movement to the threaded tubulars being connected and a torque sub releasably connected to the top drive such that the torque sub rotates with the rotating top drive during tubular connection. The torque sub comprises one or more sensors for measuring rotational, torque and torsion parameters during make up of the threaded tubulars; a wireless power source and a signal transmitter connected to the first sensor and second sensor for wireless transmission of data collected by the first sensor and the second sensor. The system further comprises a casing running tool releasably connected to the torque sub at a first end and releasably connected to a first tubular at a second end for transmitting translational and rotational movement from the top drive to the first threaded tubular as it is connected to a second threaded tubular and a computer for wirelessly receiving and colleting data from the signal transmitter.

A first method is provided for connecting a first tubular to a second tubular. The method comprises connecting a system comprising a top drive, a torque sub and a casing running tool; releasably connecting the casing running tool to the first tubular; positioning the casing running tool and first tubular over the second tubular in a pipe string and operating the top drive to rotate the first tubular relative to the second tubular. The method further comprises collecting and wirelessly transmitting data on rotational movement and torque from the torque sub to a computer and processing, displaying and storing rotational movement and torque data in the computer. Finally, rotation of the top drive is stopped.

A second method is provided for connecting a first tubular to a second tubular. The method comprises connecting a system comprising a top drive, a torque sub and a casing running tool; releasably connecting the casing running tool to the first tubular; positioning the casing running tool and first tubular over the second tubular in a pipe string and operating the top drive to rotate the first tubular relative to the second tubular. The method further comprises collecting and wirelessly transmitting data on rotational movement and torque from the torque sub to a host transceiver connected to a computer and processing, displaying and storing rotational movement and torque data in the computer. Rotation of the top drive is stopped via a wireless signal from the computer based on an alignment between processed rotational movement and torque data and predetermined target values.

### BRIEF DESCRIPTION OF THE DRAWINGS

The present invention will now be described in greater detail, with reference to the following drawings, in which:

FIG. 1 is an exploded view of one example of the present invention;

FIG. 2 is an elevation view of one example of the present invention;

FIG. 3 is a vertical cross sectional view along line A-A of FIG. 2 of one example of the present invention;

FIG. 4a is a schematic diagram of one embodiment of the present system for making up tubular members;

FIG. 4b is a schematic diagram of one embodiment of the present system for use with drill pipe;

FIG. 5 is a schematic diagram of one embodiment of a first method of the present invention;

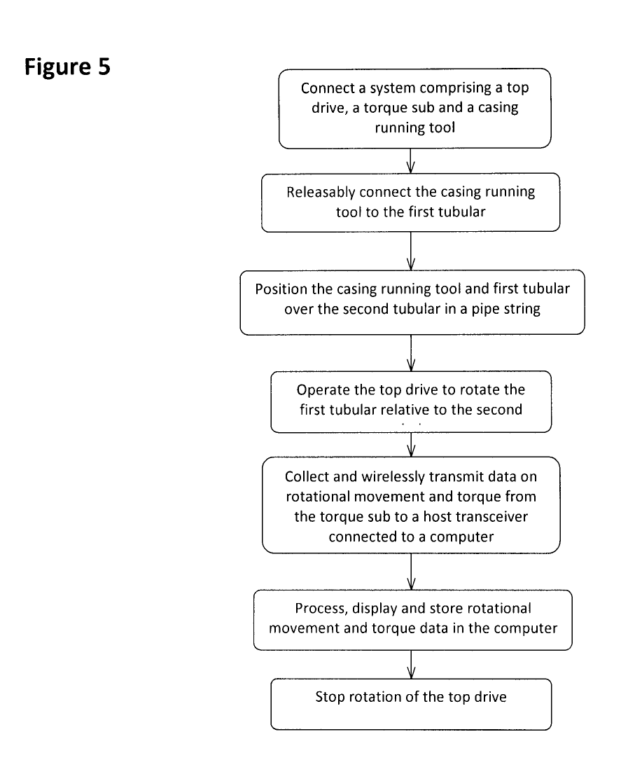

and

FIG. 6 is a schematic diagram of one embodiment of a second method of the present invention.

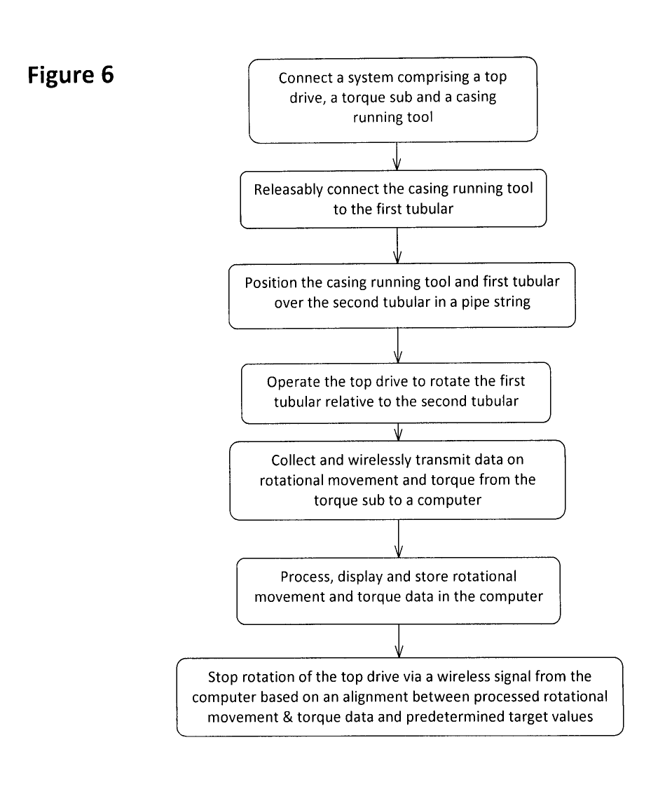

### DESCRIPTION OF THE INVENTION

The present invention relates to a torque sub for use in connection with a top drive that collects and wirelessly transmits real time data. This data can preferably include one or more of torque, turns or revolutions per minute (RPM), axial load, torsional load, internal pressure and time.

The present torque sub can provide information during a number of modes of operations including connecting tubulars in making up a casing string, drilling with casing and tubular rotation in horizontal wells.

The data collected by the present torque sub while connecting tubulars include a peak torque measurement at the point of connection, the time of peak torque, the number of turns at peak torque, the joint shoulder torque and the time and turns at shoulder. A typical graph of these data points is show below in Plot 1:

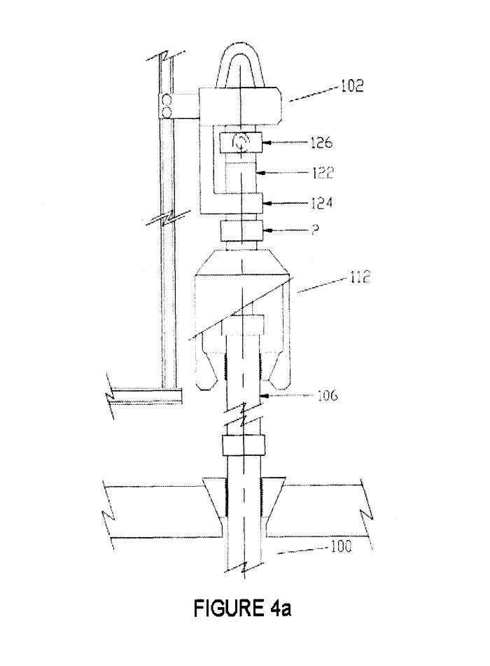

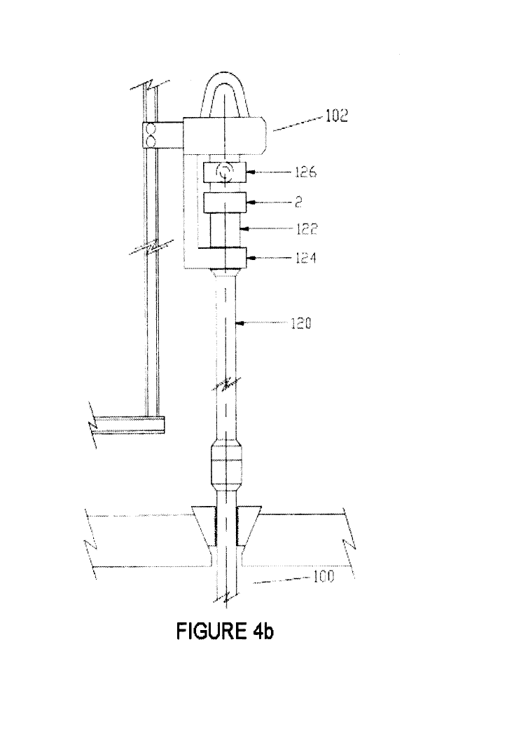

In a first mode of operation, the wireless torque sub is used to make up tubular connections, as seen in FIG. 4a. In this mode, the torque sub 2 is located at the top of the drill platform 100 under a top-drive system 102. The sensors within the torque sub measure the rotation, torque and hook load exerted by the top drive to the tubular connection to be made up 106. The tubular 106 is positioned into place by a casing running tool (CRT) of either internal grip or external grip format, or other means 112 known in the art for transmitting rotational forces the tubular. Optionally, a torque wrench 124 may be present, either above or below the torque sub 2 of the present invention.

A further blow out preventer 126 and a saver sub 122 may also be present between the top drive system 102 and the torque sub 2.

As a new connection is made up, a joint pin of a first tubular member 106 is spun into the box of the joint below it. As torque starts to rise, software within a computer determines when the torque is above a user defined reference torque level. Once the reference torque is reached, the time and turns are reset to zero. As the threads begin to engage into the box, the torque rises to the shoulder point. In one embodiment, the top drive system 102 can be stopped or shut down by the operator after a visual determination of acceptable make-up. Alternatively, the top drive 102 may comprise an integral control system or equivalent electrical current limit that can be calibrated and set to automatically interrupt the tubular makeup process at a predetermined torque value. In calibration, the reference make up torque value is reached and an equivalent pressure limit measured. This pressure limit is then used by the integral control system to determine when to stop the top drive 102. The computer preferably continues to monitor and log data until the operator stops the recording. During the interval between preparing another joint for connection, the acceptability of the connected joint is further confirmed by torque and turns settings data.

As seen in FIG. 4b, the torque sub 2 may also be used in making up or breaking out drill pipe 120, in which case, the wireless torque sub 2 is located at the top of the drill platform 100 under a top-drive system 102. The sensors within the torque sub 2 measure the rotation, torque and hook load exerted by the top drive 102 to the drill pipe 120 to be made up or broken out. The drill pipe 120 is connected to the torque sub 2 via a saver sub 122. Optionally, a torque wrench 124 may be present, either above or below the torque sub 2 of the present invention. A further blow out preventer 126 may also be present between the top drive system 102 and the torque sub 2.

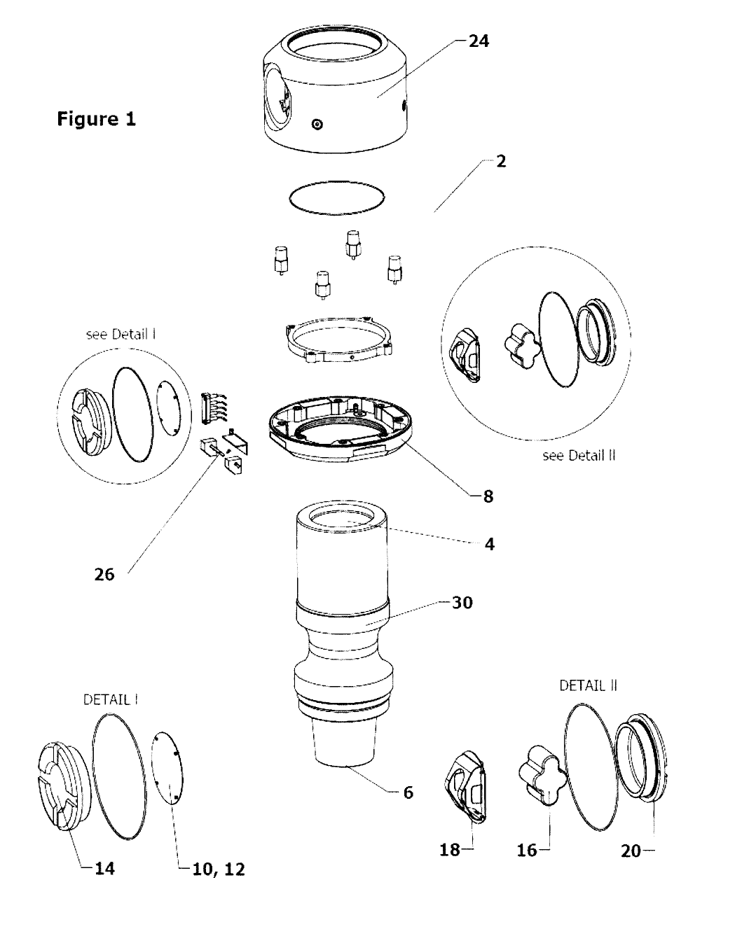

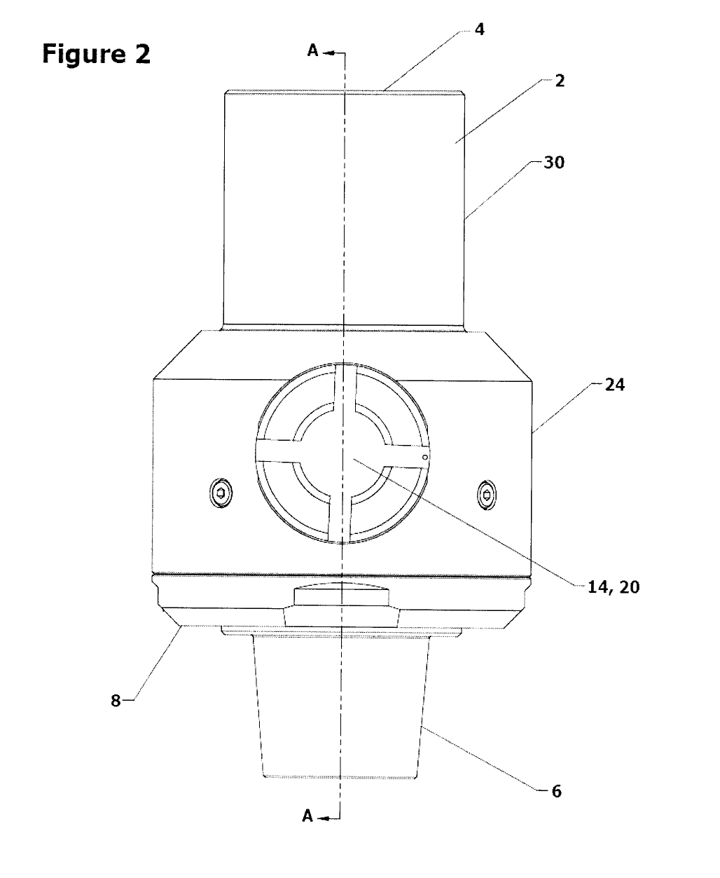

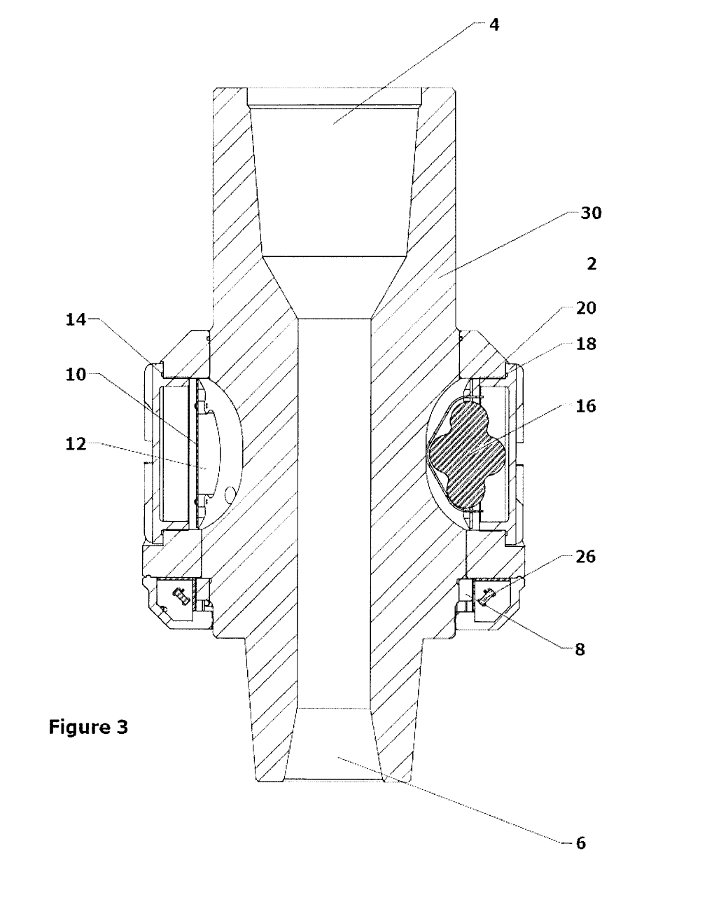

With reference to FIGS. 1, 2 and 3 the present torque sub 2 comprises a first end 4 for connection to a top drive and a second end 6 for connection to drill pipe, saver sub or casing running tool (CRT). More preferably the CRT may be of an external grip configuration, as seen in FIG. 4a, or may be of an internal grip form, also known as a torque spear, for transmitting rotational movement to the tubular.

Preferably a housing 24 is located on the torque sub 2 to contain one or more components including but not limited to one or more sensors, wired or wireless power sources and wired or wireless transmission means. More preferably the housing 24 takes the form of an enclosure ring that slips over the first end 4 of the torque sub 2. Further preferably, the housing 24 is explosion proof. Alternatively, it is possible to mount the one or more sensors, wired or wireless power sources and wired or wireless transmission means directly to the torque sub body 30 without the use of a housing 24.

In a preferred embodiment illustrated in FIG. 1, the housing 24 encloses one or more first sensors 12 and a wireless power source 16. Preferably, the wireless power source 16 takes the form of a battery pack and battery holder 18 covered by a first enclosure cover 20.

In order to access componentry such as the one or more first sensors 12 and a wireless power source 16, the housing 24 is preferably fitted with threaded circular enclosure covers rather than rectangular or square access covers with many screws. This serves to simplify design of the housing 24 and while providing ease of access to internal components.

The wireless power source 16 more preferably comprises 4D Lithium batteries in a diamond configuration, such as those manufactured by Tadiran™, although other batteries such as NiCAD, NiMH, and LifePO4 can also be used. The battery pack allows for completely wireless operation of the torque sub 2, as compared with powering the torque sub 2 through a transformer that is hardwired to the torque sub 2.

Alternately, the power source 16 in the form of an inductive transformer or coupling system that lies external to the torque sub 2. Alternate primary power sources 16 or power sources that could recharge batteries may include devices that convert vibration into electrical power, devices that convert heat from circulating drill fluids into electrical power, devices that convert hydraulic energy from circulating drill fluids into electrical power or devices that convert rotation of the drill string into electrical power.

The housing 24 may further house a wired or wireless means of transmitting data. These means can include radio signals, infrared or magnetic induction. More preferably, an antenna support ring 8 in the housing 24 supports one or more antennas 26, preferably 2 or more antennas, most preferably 4 antennas, for wireless transmission of data collected by the torque sub 2 to a host transceiver and from there to a computer. The host transceiver and computer may preferably be at a location remote to the rig. Further, the computer may be a stationary or portable device. The antenna 26 can optionally be protected and sealed against water or dust ingress. More preferably, the antenna can be sealed and encapsulated using a non-conductive epoxy or plastic sub-enclosure.

The torque sub 2 further comprises a second sensor 22 in the form of one or more strain gauges within or on its body 30 that collect data on rotational deflection of the torque sub 2. This data is then transmitted to the computer, More preferably, four sets of strain gauges are installed on the torque sub 2, two are used to measure torque and two are used to measure axial load. Measurement means may also be in place for determining internal pressure.

The first sensor 12 can be any known sensor in the art that can measure rotational movement of the torque sub 2, and therefore of the pipe string. The first sensor 12 can include accelerometers, gyroscopes, and other forms of turns counters well known in the art.

More preferably the first sensor 12 comprises one or more gyroscopes in the form of rate gyros. A preferred embodiment is illustrated in FIG. 1, in which the one or more rate gyros are incorporated onto a printed circuit board (PCB) 10 that is either mounted onto the torque sub body 30 or immediately adjacent to the torque sub body 30 when mounted within the enclosure 24. A first removable enclosure cover 14 covers the PCB 10. For the purposes of the present invention a rate gyro is defined as a type of linear inertial sensor that measures rotational direction. A rate gyro acts to provide a velocity measurement and outputs a voltage in relation to this.

The rate gyro can further preferably take the form of a micro-electro-mechanical system (MEMS). The MEMS form rate gyro is typically packaged similarly to an integrated circuit and may provide either analog or digital output. In a preferred embodiment, the present PCB 10 comprises a single rate gyro to provide rotational data for the primary rotational axes.

Additional gyro's can be incorporated for refining speed and rotational accuracy.

The rate gyro is preferably mounted with its axis of rotation parallel to the axis of rotation of the wireless torque sub 2 as depicted in the following diagram:

Due the heavy vibrations on the rig and large rotational forces experienced by the drill string and the torque sub, the positioning of the rate gyro immediately adjacent the torque sub body 30, helps to ensure that the rate gyro remains parallel with the torque shaft of the torque sub, to provide a more accurate reading of tubular rotational movement. It may also increase the durability and reduce weight of the full torque sub assembly.

The present rate gyro provides a non-mechanical means of measuring angular displacement and turn data. The data collected by the present torque sub 2 does not require compensation for torsional deflection. As such, the present torque sub 2 is not required to work in connection with any additional fixed reference points.

The torque sub 2 provides a voltage output that is proportional to the angular speed, or rate of rotation. The voltage is digitized using an analog to digital converter and processed within a processor or microcontroller. This provides an indication of velocity. Calculations are then performed to integrate the change in angle over time and recover the angular position. This measurement technique and calculation provides a relative turns measurement in relation to when the offset or ‘zero’ was measured. The ‘zeroing’ is initiated automatically or by the operator and is performed when the device is not in motion.

In a first preferred embodiment of use, the present torque sub 2 collects and transmits torque and rotational data that can be used to confirm the acceptability of makeup of the tubular connection. In this embodiment, a first operator at the drilling rig can examine the makeup for acceptability and then manually stop the makeup operation by stopping the top drive 102.

Alternatively, the top drive 102 may comprise an integral control system or equivalent electrical current limit that can be calibrated and set to automatically interrupt the tubular makeup process at a predetermined torque value. In calibration, the reference make up torque value is reached and an equivalent pressure limit measured. This pressure limit is then used by the integral control system to determine when to stop the top drive 102. Data collected from the torque sub 2 is processed, reviewed and stored on the computer. A second operator reviews the processed data to further confirm acceptability of the make up. Should the tubular make up be considered acceptable based on the processed data, the next tubular connection is prepared for make up. Should the tubular make up be considered not acceptable based on the processed data, the tubular connection is redone.

In a second embodiment, two-way wireless communication between the top drive 102 and the computer allows for control the top drive from the computer. In this way, once an acceptable makeup is determined from plotting of the data from the torque sub 2, it is possible to send a signal to the top drive 102 to interrupt the top drive's integral control system and to automatically and remotely stop its operation.

Battery power consumption during operations is preferably minimized by a number of operational considerations. In one preferred mode of operation during tubular makeup, the data sampling frequency of the torque sub 2 is kept low until the predetermined reference torque is reached, at which time output sampling frequency is increased to capture more crucial data as torque increases more rapidly after shouldering. Decision-making is based on the change in time and the change in torque signals. This creates a variable output rate. Preferably, output sampling frequency prior to reaching the reference torque is 1 to 10 times per second, and then is able to reach 240 to 480 samples per second after reaching reference torque. Lastly, the system also captured the peak torque once the torque reference has been reached. At the end of the capture, the peak torque information is returned to the host system for recording. The PCB 10 design comprises a processor/communications module comprising an analog processing board, a power system and power control board, and an inertial sensor board. A host transceiver, preferably in the form of a computer serial port or bus, plugs into a port of the stationary computer to thereby transmit data to the computer. Wireless hardware connected to the stationary computer may uses any suitable interface for connecting and communicating with the host transceiver.

The second mode of operation, the present system can be used in drilling with casing (DWC) operations. In DWC operations, the casing is rotated at the surface to transmit torque to the drilling bottom-hole assembly. A drillable drill bit at the end of the casing sting drills into the formation during DWC and can also be drilled through so that the casing can be cemented in place. In this mode of operation, the top drive is connected to the wireless torque sub, which is in turn connected to a CRT or similar device for lifting and positioning the casing and transmitting rotational forces from the top drive to the casing, and then the casing to be drilled. The additional stresses and wear experienced by casing during DWC can lead to casing failure, fatigue and buckling. It is therefore important to monitor and assess torque of the casing during DWC operations.

In the third mode of operation, after tubular makeup is completed, the casing string may be run down into a horizontal well. This application also requires rotation of the casing string, in order to run it properly into the horizontal well. In this mode, torque, hook load, turns and RPM are recorded at 0.1 to 5 second intervals, and preferably at 1-second intervals. The data storage rate is adjusted to about 1 sample per second. Sampling rate by the sensor measurement system is preferably set at 10 samples per second however faster sampling rates are also possible and encompassed by the scope of the present invention. Measurements in this mode of operation are used to observe rotations of the string as it engages into a horizontal well to determine fatigue levels of joints. As with the first mode of operation sampling and measurement frequency may be set at a first rate prior to reaching a preset value for a certain variable, and then sampling rate maybe increased upon reaching the present value and beyond. In this way, power is optimized while also optimizing data collection at a critical juncture in the operation.

### EXAMPLES

The following examples serve merely to further illustrate embodiments of the present invention, without limiting the scope thereof, which is defined only by the claims.

### Example 1

A method is devised for monitoring the makeup of a pair of threaded tubulars using the present torque sub, in wireless communication with a stationary computer. The torque sub measures torque, turns, hook load and time. This information is then transmitted to a computer, via a host transceiver.

The torque range is set at −50000 to +50000 ft-lbs and the torque resolution is set to 2 ft-lbs or better. The torque bridge cell resistance is set to 350 Ω or greater with the imbalance on the bridge being no more than %10 of full-scale mV output.

The torque bridge fast sampling rate can reach between 240 to 480 Samples/second, during final make-up stage when torque is greater than the reference torque set in software. The torque bride slow sampling rate is set between 10 and 50 Samples/second during the initial stages of makeup, to thereby minimize battery power consumption.

The hook-load range is set at −250000 to +750000 lbs, with a hook-load sampling rate of 1 to 10 Samples/second. The hook-load bridge resistance shall be 350 Ω or greater, with the imbalance on the bridge being no more than %10 of full-scale mV output.

The turns resolution is set at least at 0.01 turns with an accuracy of 1% or finer over a single turn, not including vibration-induced errors. The maximum system operating RPM is 125 RPM and the measurement variation of the turns does not include any error induced by vibration that would occur on the inertial turn's sensor.

The following flow diagram shows a base-line algorithm that can be used to convert the rate of change into a relative angular rotation or turns measurement:

Preferably, to further reduce sensitivity to electrical or mechanical noise, a noise threshold detector can optionally be used before the integration is calculated. Additional samples can optionally be measured and/or low pass filtering adjusted to reduce noise errors. Digital Signal Processing (DSP) can also be used to further improve the performance.

In the foregoing specification, the invention has been described with a specific embodiment thereof; however, it will be evident that various modifications and changes may be made thereto without departing from the broader spirit and scope of the invention.

1. A device for measuring and wirelessly transmitting one or more parameters during wellbore operations, said device comprising:
a) a torque sub releasably connected to a top drive at a first end and having a second end such that the torque sub rotates with the rotating top drive;
b) one or more sensors for measuring rotational, torque and torsion parameters;
c) a wireless power source; and
d) a signal transmitter connected to the one or more sensors for wireless transmission of data collected by the one or more sensors to a computer.

2. The device of claim 1, wherein the one or more sensors comprise a first sensor for measuring rotational motion of the torque sub and a second sensor mounted within the torque sub for measuring axial torsion forces between the top drive and a pipe string.

3. The device of claim 2, wherein the second sensor comprises one or more strain gauges.

4. The device of claim 2, wherein the first sensor comprises one or more rate gyros.

5. The device of claim 4, wherein the one or more rate gyros are incorporated into a printed circuit board mounted on a body of the torque sub.

6. The device of claim 4, wherein the one or more rate gyros are incorporated into a printed circuit board and mounted immediately adjacent to the torque sub.

7. The device of claim 4, wherein the one or more rate gyros are positioned with their axis of rotation parallel to an axis of rotation of the torque sub.

8. The device of claim 4, wherein the one or more rate gyros are micro-electro-mechanical systems (MEMS).

9. The device of claim 1, wherein the wireless power source is a battery pack.

10. The device of claim 1, wherein the signal transmitter comprises one or more antennae.

11. The device of claim 1, wherein the signal transmitter comprises four antennas.

12. The device of claim 11, wherein the antennas are housed on a support ring that is protected and sealed against water or dust ingress.

13. A device for measuring and wirelessly transmitting one or more parameters during wellbore operations, said device comprising:
a) a torque sub releasably connected to a top drive at a first end and having a second end such that the torque sub rotates with the rotating top drive;
b) one or more sensors for measuring rotational, torque and torsion parameters;
c) a wireless power source; and
d) a signal transmitter connected to the one or more sensors for wireless transmission of data collected by the one or more sensors to a computer,
wherein the one or more sensors, wireless power source and signal transmitter are enclosed within a housing on the torque sub.

14. The device of claim 13, wherein the housing comprises an enclosure ring encircling the first end of the torque sub.

15. The device of claim 14, wherein the one or more sensors, wireless power source and signal transmitter are accessible via one or more secure, easily accessible covers on the enclosure ring.

16. A system for connecting threaded tubulars for use in a wellbore comprising:
a) a top drive for imparting rotational movement to the threaded tubulars being connected;
b) a torque sub releasably connected to the top drive such that the torque sub rotates with the rotating top drive during tubular connection, said torque sub comprising
i. one or more sensors for measuring rotational, torque and torsion parameters during make up of the threaded tubulars;
ii. a wireless power source; and
iii. a signal transmitter connected to the first sensor and second sensor for wireless transmission of data collected by the first sensor and the second sensor;
c) a casing running tool releasably connected to the torque sub at a first tool end and releasably connected to a first tubular at a second tool end for transmitting translational and rotational movement from the top drive to the first threaded tubular as it is connected to a second threaded tubular; and
d) a computer for wirelessly receiving and colleting data from the signal transmitter.

17. The system of claim 16, wherein the one or more sensors comprise a first sensor for measuring rotational motion of the torque sub and a second sensor mounted within the torque sub for measuring axial torsion forces between the top drive and the pipe string.

18. The system of claim 17, wherein the second sensor comprise one or more strain gauges.

19. The system of claim 17, wherein the first sensor comprises one or more rate gyros.

20. The system of claim 19, wherein the one or more rate gyros are incorporated into a printed circuit board mounted on a body of the torque sub.

21. The system of claim 19, wherein the one or more rate gyros are incorporated into a printed circuit board and mounted immediately adjacent to the torque sub.

22. The system of claim 19, wherein the one or more rate gyros are positioned with their axis of rotation parallel to an axis of rotation of the torque sub.

23. The system of claim 19, wherein the one or more rate gyros are micro-electro-mechanical systems (MEMS).

24. The system of claim 16, wherein the wireless power source is a battery pack.

25. The system of claim 16, wherein the signal transmitter comprises one or more antennae.

26. The system of claim 16, wherein the signal transmitter comprises four antennas.

27. The system of claim 26, wherein the antennas are housed on a support ring that is protected and sealed against water or dust ingress.

28. The system of claim 16, wherein the one or more sensors, wireless power source and signal transmitter are enclosed in a housing on the torque sub.

29. The system of claim 28, wherein the housing comprises an enclosure ring encircling a first end of the torque sub.

30. The system of claim 29, wherein the one or more, wireless power source and signal transmitter are accessible via one or more threaded access covers on the enclosure ring.

31. A method for connecting a first tubular to a second tubular, said method comprising the steps of:
a) connecting a system comprising a top drive, a torque sub and a casing running tool;
b) releasably connecting the casing running tool to the first tubular;
c) positioning the casing running tool and first tubular over the second tubular in a pipe string;
d) operating the top drive to rotate the first tubular relative to the second tubular;
e) collecting and wirelessly transmitting data on rotational movement and torque from the torque sub to a computer;
f) processing, displaying and storing rotational movement and torque data in the computer; and
g) stopping rotation of the top drive.

32. The method of claim 31, wherein rotation of the top drive is stopped by an operator at the top drive upon inspection of the tubular connection.

33. The method of claim 31, wherein rotation of the top drive is stopped automatically by an integral control system within the top drive upon reaching a preset internal pressure value correlated to a reference torque value.

34. The method of claim 31, further comprising the steps of:
a) reviewing acceptability of tubular make-up after stopping rotation by studying processed rotational movement and torque data; and
b) determining next steps based on results of processed rotational movement and torque data,
wherein, the next step is making up subsequent tubular connections if tubular make up is acceptable or the next step is redoing the tubular connection if tubular make up is not acceptable.

35. The method of claim 31, wherein rotational movement data is measured by a first sensor housed on the torque sub, axial torsion forces between the top drive and a pipe string are measured by a second sensor located within the torque sub and wherein data on rotational movement and torque are wirelessly transmitted by a signal transmitter connected to the first sensor and second sensor.

36. The method of claim 35, wherein the second sensor comprises one or more strain gauges.

37. The method of claim 35, wherein the first sensor comprises one or more rate gyros.

38. A method for connecting a first tubular to a second tubular, said method comprising the steps of:
a) connecting a system comprising a top drive, a torque sub and a casing running tool;
b) releasably connecting the casing running tool to the first tubular;
c) positioning the casing running tool and first tubular over the second tubular in a pipe string;
d) operating the top drive to rotate the first tubular relative to the second tubular;
e) collecting and wirelessly transmitting data on rotational movement and torque from the torque sub to a host transceiver connected to a computer;
f) processing, displaying and storing rotational movement and torque data in the computer; and
g) stopping rotation of the top drive via a wireless signal from the computer based on an alignment between processed rotational movement and torque data and predetermined target values.

39. The method of claim 38, further comprising the steps of:
a) reviewing acceptability of tubular make-up after stopping rotation, by studying the processed rotational movement and torque data; and
b) determining next steps based on results of processed rotational movement and torque data,
wherein, the next step is making up subsequent tubular connections if tubular make up is acceptable or the next step is redoing the tubular connection if tubular make up is not acceptable.

40. The method of claim 39, wherein rotational movement of the torque sub is measured by a first sensor housed on the torque sub, axial torsion forces between the top drive and a pipe string are measured by a second sensor located within the torque sub and wherein data on rotational movement and torque are wirelessly transmitted by a signal transmitter connected to the first sensor and second sensor.

41. The method of claim 39, wherein the second sensor comprises one or more strain gauges.

42. The method of claim 39, wherein the first sensor comprises one or more rate gyros.
